(19) United States
(12) Patent Application Publication
(10) Pub. No.: US 2002/0156729 A1
(43) Pub. Date: Oct. 24, 2002

(54) PAYMENTS IN A TELECOMMUNICATIONS SYSTEM

(76) Inventor: PATRIK NILSON, TURKU (FI)

Correspondence Address: NIXON & VANDERHYE P C, 1100 N GLEBE ROAD, 8TH FLOOR, ARLINGTON, VA, 22201

(21) Appl. No.: 09/340,181

(22) Filed: Jun. 28, 1999

(30) Foreign Application Priority Data
Jul. 6, 1998 (FI) 981553

(51) Int. Cl. G06F 17/60

(52) U.S. Cl. 705/40

(57) ABSTRACT

The present invention relates to a method and arrangement for paying through a cellular telecommunications system. The cellular telecommunications system comprises a user account providing a balance to a user and accessible through the telecommunications system, wherein the balance on the user account is deductible on request, and a switching center through which the user is currently communicating by means of a mobile station. The method comprises a step of transmitting a balance information from the user account to the database of the switching centre the user is currently communicating with.

### FIELD OF THE INVENTION

The present invention relates to a method for accomplishing payments in a telecommunications system. The invention relates further to an arrangement and apparatus for implementing payment operations in a telecommunications system.

### BACKGROUND OF THE INVENTION

Services, such as telephone calls, various inquiries, calls to specific service numbers and etc. services obtainable through a telecommunications network system may be charged by various alternative manners. Usually the charging or billing is done in accordance with the used calling time, in accordance with the product or services purchased or used, or then there may be a fixed price per a single call or other service obtained through the telecommunications system.

In many instances it is preferred to be able to charge the price of the call or other service beforehand, so that the operator will avoid any credit losses of unpaid telephone bills and services, especially in a case where the caller and consumer of the service is not an actual subscriber of the particular operator (i.e. there is no agreements between the caller and the operator).

The prior art proposes different solutions to provide a Prepayment Service in a telecommunications system. A conventional way of precharging the calls is a telephone operable with coins or notes. This, however, requires a lot of maintenance and service. In addition, some of the users may feel it uncomfortable to have a sufficient amount of coins with them. The needed amount of coins may also be substantially big, e.g. when making an international call or accessing certain chargeable service numbers and services. The public money phones are also easy and common targets for robberies.

More recent possibility for charging calls beforehand is such that the operator sells prepaid calling cards including a desired amount of loaded money for the calls (for a certain calling time). Usually these cards are provided with a magnetic strip, or in some cases even with some kind of intelligence (so called smart cards), and thus the caller has to use a telephone provided with a suitable magnetic strip reader or a smart card reader. During a call units corresponding the spent money are decreased continuously from the card, and after all the money has been spent the call becomes terminated.

So called “real-time output” of call data records towards a Billing Gateway or some other pre/postprocessing system are also proposed and in use. These do not require any specific magnetic cards, smart cards or similar. At present the most common “real-time output” system for the Prepaid Services is Hot Billing by ORGA. However, in practice these “real-time output” systems are not operating as a real real-time system, since there is always a delay before a call data record is output to the system (currently the delay is at least two minutes).

Another possibility for Prepaid Services without a need to use magnetic strips, smart cards or similar means are solutions in which e.g. a specific (personal) number string is used by the user when initiating a call. These approaches are usually based on an Intelligent Network (IN) service. In these the user has to call to a special service where he/she has an individual user account into which he/she has preloaded money for the calls. The user may have a card, e.g. so called PPMA (Pre-Paid Mobile Access) service card or scratch-surface calling card, or voucher either for ordinary fixed line telephones of a PSTN (Public Switched Telephone Network) or for mobile telephones of a PLMN (Public Land Mobile Network). In view of these prepaid cards or vouchers a reference is made to applicant's U.S. patent application Ser. No. 08/836,371 (corresponds WO publication 96/15633), and especially to FIG. 5 thereof, which application is incorporated herein by reference. Almost every telephone can be used when using these cards, as they do not require any specific reading devices.

In the above prior art disclosure the monitoring can be accomplished for the calls made by a predefined telephone subscription or by means of a special prepaid card. The use of the prepaid cards enables the user to call from any phone whatsoever, and yet the call will be charged against the user's account, which has a certain pre-set balance indicated by the card. The user of the service has an Account Code (AC) and a Personal Identification Number (PIN). The call signal of the subscriber is triggered to a Service Control Point (SCP) of an IN (intelligent network) using the account code AC and A-number or B-number as a trigger key. The authority to use the card may be checked on the basis of the A-number, mobile phone number MSISDN or personal identification number PIN of the subscriber. The SCP checks the subscriber database in the IN to see the current balance of the subscriber and notifies the subscriber of the status of the account by a voice message or on the display of the subscriber terminal.

If the account is empty, the call procedure is released, and if the balance is positive, the connection to the call destination is initiated. If the called party replies, charging is started on the basis of the charging information and the pulses are received from the exchange in order to update the balance of the account associated with the card. In addition, the call can be monitored in respect of other conditions indicated in the subscriber record. During the call and at the end of the call, the subscriber's account shows the real time balance, and if the account is empty, desired further processing follows.

In addition, it is prior known to have such SIM (SubscriberIdentity Module) cards for mobile telephones by means of which the calling time is limited. This is accomplished such that the card enables an access to a database containing information about the allowed maximum calling time for outgoing calls, which information is then transmitted to and processed by means of the PLMN apparatus e.g. in a manner similar to the above disclosed.

During a call the prior art prepayment services utilize a central account control and monitoring unit (e.g. an IN node) implemented in the telephone network. This central unit monitors the amount of money left either in a card or in the account associated e.g. to a certain prepaid calling card. In case there is no or too little balance left in the account, the call cannot be continued or new calls cannot be initiated.

From the point of view of the telephone operators, the above card solutions are substantially safe, as the calls are always charged beforehand. The distribution and sales of the cards can also be arranged substantially easily and efficiently e.g. from various outlets, such as from shops, kiosks, newspaper stands, tobacco shops etc.

The above prior art arrangements, however, do still have some disadvantages. One problem is that the capacity of the present IN solutions is limited. Due to an ever increasing demand for this kind of services the capacity is forming a bottleneck for the operators as they are not able to support as many subscribers as they would like to. Another problem relates to the costs, since an operator has to invest in an IN node or similar central prepayment services unit including a lot of expensive hardware and software. The IN solutions are also usually built, or more precisely put together, from unstandardized products and components of several manufacturers, and all the components are not always built on high available platforms (e.g. a SEMA equipment).

### SUMMARY OF THE INVENTION

It is an object of the present invention to overcome the disadvantages of the prior art solutions and to provide a new type of solution for paying through a telecommunications system.

An object of the present invention is to provide a solution by means of which the delays during payment proceedings are decreased.

An object of the present invention is to provide a solution by means of which more capacity for payment services provided by means of a central payment service implementation, such as an intelligent network (IN) service or similar facility, is increased.

An object of the present invention is to provide a solution by means of which even such mobile communications subscribers who have roamed outside their home cellular network area are enabled to use prepayment services provided by their home network.

An object of the present invention is to provide a solution by means of which a prepayment service is available in a similar manner for mobile subscribers regardless the actual position of the subscribers and the mobile switching centre they are communicating with.

Other objects and advantages of the present invention will be brought out in the following part of the specification taken in conjunction with the accompanying drawings.

The objects are obtained by a new method of paying services through a cellular telecommunications system. Said cellular telecommunications system comprises a user account providing a balance to a user and accessible through the telecommunications system, wherein the balance on the user account is deductible on request, and a switching centre through which the user is currently communicating by means of a mobile station, wherein the switching centre includes a database for storing information relating to the user. The method comprises a step of transmitting a balance information from the user account to the switching centre the user is currently communicating with.

An arrangement for providing a prepayment service for a user communicating by means of a mobile station in a cellular telecommunications system comprises a user account accessible through the telecommunications system, wherein the user account is arranged to enable the user to pay for the services in beforehand by having balance on said user account deductible upon a request, a switching centre through which the user is enabled to communicate towards the telecommunications system by means of the mobile station, the switching centre including a database for storing user related information. The arrangement is such that the switching centre the user is currently switched to is arranged to receive and locally control and process a balance information transmitted from the user account to the switching centre.

A switching centre for a cellular telecommunications system comprises a local database for receiving and storing user related information, a local user account implemented by means of said database and means for controlling and processing balance information received from a central user account and stored in said local user account as a local balance.

Several advantages are obtained by means of the present invention. The solution provides a controllable manner for distributing the handling and managing operations of the (pre)payment service implemented within a cellular system from a central node to several subnodes, such as to switching centres, and thus physically and geographically closer to the actual users of the prepayment service. The capacity of a prepayment service is increased, and the prepayment service can be supported for a relatively large subscriber base. The solution provides a real-time prepayment service which e.g. disconnects a call immediately after the balance in the subscriber account has been used or has been deducted below a predetermined value. The solution enables roaming subscribers to use the prepayment service transparently in a similar manner as they were in their home network. However, only relatively small changes are required to the existing functionality of a present PLMN system to be able to provide the solution disclosed herein.

In the following the present invention and the other objects and advantages thereof will be described in exemplifying manner with reference to the annexed drawings, in which similar reference characters throughout the various figures refer to similar features.

### BRIEF DESCRIPTION OF THE DRAWINGS

FIG. 1 is an exemplifying schematic presentation of a general structure of telecommunication systems and intelligent networks (INs) implemented in connection thereof;

FIG. 2 is a schematic presentation of one IN arrangement;

FIG. 3 discloses a general flow chart for one embodiment of the present invention; and

FIG. 4 discloses a flow chart for payment operations in accordance with one embodiment of the present invention.

### DETAILED DESCRIPTION OF THE DRAWINGS

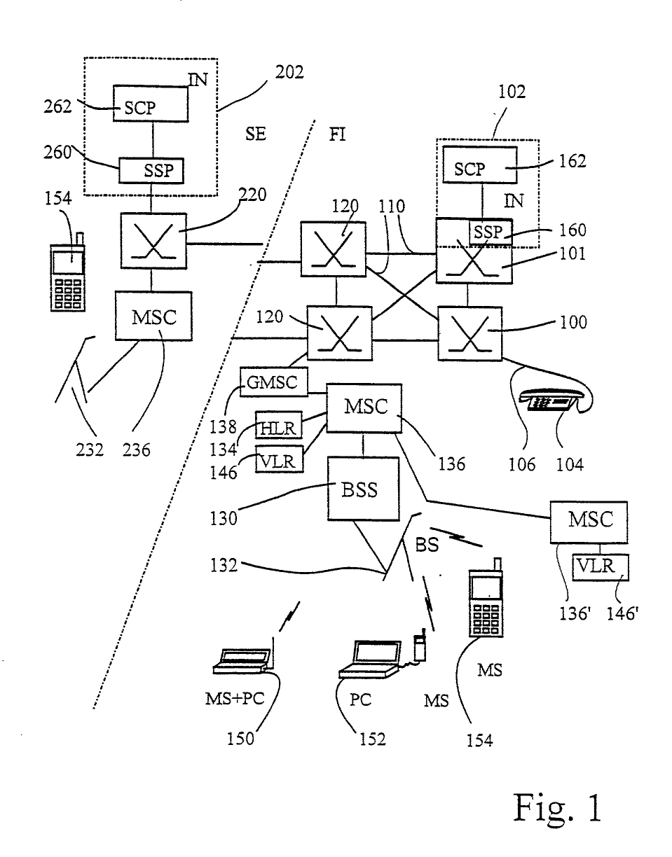

Firstly, a general structure of a telecommunications system will be explained with reference to FIG. 1 so as to give a better understanding of the basis of the invention.

FIG. 1 is a schematic presentation of one telecommunications system including a public switched telephone network (PSTN) providing communications connections between the users or subscribers thereof. The PSTN comprises a plurality of local exchanges 100 and 102 and a plurality of transit exchanges 120. The local exchanges and the transit exchanges are interconnected with each other by trunk lines 110. The local exchanges 100, 102 or transit exchanges 120 can be based on the well known AXE digital switching system, which is offered by the assignee, Telefonaktiebolaget L M Ericsson.

The telecommunications system of FIG. 1 includes further two cellular networks or Public Land Mobile Networks (PLMNs), e.g. GSM based Public Land Mobile Networks (PLMN), connected to the PSTN or a similar facility, such as to an Integrated Services Digital Network (ISDN). The necessary links between the various telephone systems are well known in the art. In the example of FIG. 1 the PLMN includes a Gateway Mobile Services Switching Centre (GMSC) 138 which is connected to several switching centres, and more precisely to Mobile Services Switching Centres (MSC) 136, which in turn are connected to plurality of base station Subsystems (BSS) 130.

Each BSS 130 is connected to at least one Base Station (BS) 132. Each of the Base Stations supervises a predefined geographical area called as a cell. An arbitrary geographical area may be divided into plurality of radio coverage areas, i.e. into said cells (not shown). To summarize, the arrangement is such that mobile stations or transceivers 150, 152, 154 are communicating via a radio (i.e. an air) interface with the nearby base station 132, which in turn is connected via the BSS to the mobile switching center MSC, which is then connected to another telephone system via a suitable linking apparatus, such as the GSMC.

The mobile stations, such as the MS 154, are free to roam from the coverage area of one MSC to the coverage area of another MSC, e.g. from MSC 136 to MSC 136′, and even to a coverage area of a MSC 236 of another or foreign network operator (Finnish and Swedish mobile networks illustrated as an example). The connections between telecommunications systems of various countries can be provided in a per se known manner.

The PLMN includes further a central database, so called Home Location Register (HLR) 134. The HLR is used for the management of mobile subscribers. The information stored in the HLR comprises subscriber information and a part of the mobile station location information allowing incoming calls to be routed to the roaming mobile stations. In addition, the HLR stores three identities used in the system: an International Mobile Subscriber Identity (IMSI), a Mobile Station ISDN number (MSISDN) and a Visitor Location Register (VLR) address.

The number of the HLRs in one PLMN varies according to the characteristics of the PLMN itself. A HLR may be connected to so called central Mobile Services Switching Centre MSC 136, and also to all local MSCs and even to the to the GMSC 138 in the PLMN. The mobile stations or units 150, 152, 154 subscribing the PLMN are registered in one HLR of the network. The HLR contains information for each mobile subscription concerning the IMSI and MSISDN as well as said location information (VLR number or address), basic telecommunications services subscriber information, service restrictions and supplementary services and etc.

Each of the MSCs 136 includes further a local database called a Visitor Location Register VLR 146 or 146′, in which all such mobile stations are registered which are located within the coverage area of one of the associated cells of the given MSC. The VLR is the functional unit that dynamically stores subscriber information, such as location area, when the subscriber is located in the area of which the VLR concerned is in charge. When a roaming mobile station enters a new MSC coverage area, this MSC then “warns” the associated VLR of the entrance, and the mobile station enters into a registration stage through which it is assigned a Mobile Subscriber Roaming Number (MSRN) or a visited network address that serves to route incoming calls to the mobile station in question.

The VLR contains also some other information required so that the MSC is enabled to handle the incoming/outgoing calls. This information is gathered by the VLR via a dialogue with that particular HLR which is associated with the particular mobile station or subscriber concerned. This information includes e.g. the Mobile Subscriber/Station Roaming Number (MSRN), a temporary mobile subscriber identity (if applicable), the location area in which the mobile station has been registered and data relating to supplementary service parameters.

Thus the system is such that those mobile stations belonging to a given PLMN and located at the moment within a cell area controlled by MSC 136 or MSC 136′ are registered temporarily in the VLR 146 of the MSC 136 or the VLR 146′ of the MSC 136′ and permanently in one HLR, which may be another MSC or the same MSC 134, at the same time. The HLR is always informed about the VLR in which the mobile station is registered.

It is to be noted that even though the schematic FIG. 1 shows only some of the MSCs, BSSs, HLRs, VLRs and BSs for the cellular networks, there may be a great number of these network elements in each of the PLMNs.

In addition to the functionality and information referred to above, the MSC 136, and more precisely, the HLR 134 of the subscriber comprises central user accounts utilized in the present prepayment arrangement. Therefore, according to this embodiment, the MSC comprising the HLR can be denoted as central node of the prepayment service. The functionality if the central node will be explained in more detail after the following description of the bases for another embodiment of the central node.

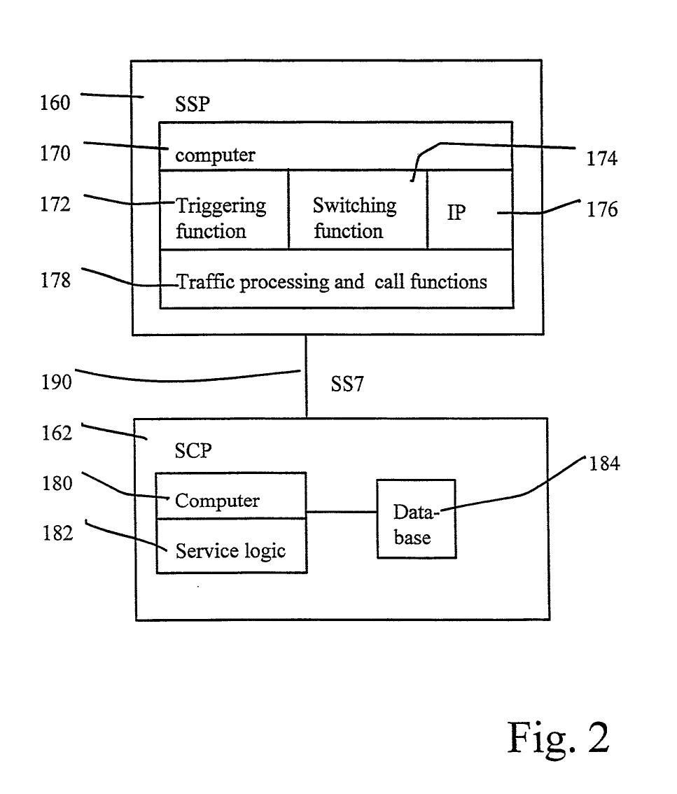

According to another embodiment the central node for the prepayment service is implemented by means of an intelligent network (IN) node. To give a better understanding of this embodiment, an explanation of an Intelligent network (IN) service enabling various switching and charging operations of calls and other services will be explained with reference to FIGS. 1 and 2.

As is disclosed by FIG. 1, telecommunications network system may comprise further one or more intelligent network nodes 102 for providing Intelligent Network services, such as the prepayment services with user accounts. The Intelligent Network nodes (IN nodes) 102 and 202 interface with the traditional telecommunications network, such as the PSTN or PLMN. Each of the operators may have one or several intelligent networks of their own (two disclosed in the example of FIG. 1).

An Intelligent Network IN may be defined as an architecture which can be applied to the most of the communications networks regardless the used network technology. The object thereof is to create, control and manage teleservices providing surplus value. One special feature of the IN is to be able to provide modular operations which can be linked to each other as components when creating new services, whereby the definition and designing of new services will become easier. The services are separated from the physical network structure which is disposed at the lowest level, and thus it is possible to distribute them. CCITT (International Telegraph and Telephone Consultative Committee) has defined so called Intelligent Network Conceptual Model (INCM) of the intelligent network in the recommendation CS-1 (Capability Set 1), which is incorporated herein by reference.

An IN node 102 usually includes a service switching processor, which is sometimes referred to in the industry as a Service Switching Point (SSP) 160. In principle the SSP 160 can be seen as a local exchange 101 provided with an additional software used to identify the intelligent network (IN) calls. The SSP 160 is in turn connected to a service control processor, which is sometimes referred to as a Service Control Point (SCP) 162.

FIG. 2 is a more detailed disclosure of the SSP and SCP. The SSP 160 includes a computer or processor 170, an intelligent peripheral 176 that performs a number of advanced functions of the IN, such as voice recognition, a triggering function 172, a switching function 174 and a traffic processing and call control functions 178. A communications connection 190, such as a SS7 connection (signalling system No. 7, which is standardized by CCITT) connects the SSP to the SCP 162. The SCP 162 includes a computer or processor 180 and a service logic for implementing various advanced services provided by the intelligent network IN, such as call forwarding and prepayment services. It is also possible to integrate the SSP and the SCP into a single Service Switching and Control Point Processor (SSCP). In either implementation the service logic 182 is independent of the network access and transport implementation.

According to the first embodiment already referred to in the above the MSC 136 provides an access via the communications network to a prepayment service provided by the HLR 134, and according to the further embodiment the SSP 160 provides an access to the prepayment service provided by the SCP 162. However, it is to be understood that these can be replaced by some other apparatus providing similar functionality, i.e. central user accounts. In the following the apparatus implementing the central user accounts will be referred to central nodes or central nodes for prepayment services.

The prepayment service provides the user with a central user account which can be implemented in a database of the central node (e.g. HLR 134 or SCP 162). The user account enables the user to pay for services in beforehand by loading a desired amount of balance on said user account, which balance is then deductible upon a payment, i.e. after a request to do so. The used switching apparatus forwards requests directed to the prepayment service to the central node so as to establish an interaction between the prepayment service and the calling device, i.e. device willing to communicate with the prepayment service.

Now, instead of establishing a connection to said user account implemented within the central node each time a payment is to be made, a balance information is sent once from the central node to a MSC the user is currently connected to, and more precisely to a VLR of the current MSC. The transmitting is accomplished e.g. when the mobile station roams into the coverage area of said MSC. The transmittal of the balance information can occur in the same transmission in which the other necessary subscriber related information is sent to the new MSC during the handover between two MSCs, such as from MSC 136 to MSC 136′ or even to MSC 236. Thus that MSC to which the mobile station is currently registered in has always the latest balance information. In case of payment, the balance is then deducted locally from a balance corresponding or computed on the basis of the received balance information in the Visitor Location Register VLR of the current MSC.

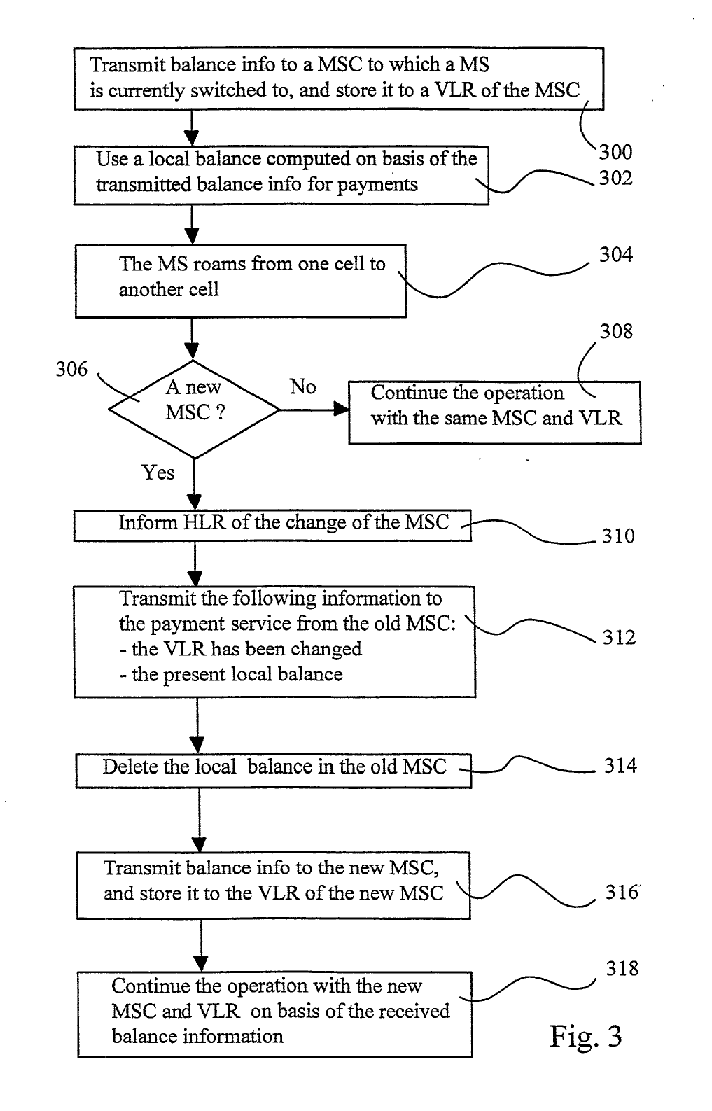

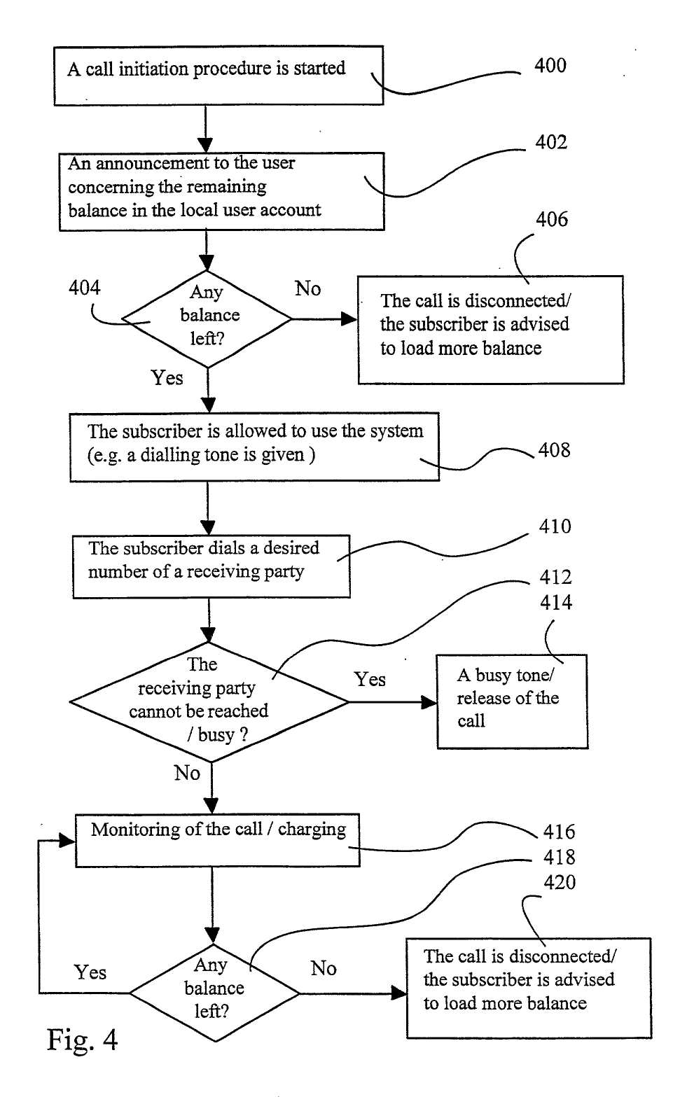

The operation of the arrangement and handovers between various MSCs are disclosed in more detail by flow chart of FIG. 3. At stage 300, a balance information is transmitted from the payment service user account in the central node database to a MSC with which the MS of the holder of the account is currently communicating, i.e. to which MSC the MS is currently switched to. In case of a payment, the local balance is then deducted accordingly. The already existing traffic control and charging functionality of the PLMN, such as Charging Analysis and Call Teardown, can be used in this (see. FIG. 4). The local balance is deducted until a threshold value in the balance is reached, whereafter it is possible e.g. to disconnect the call or to give a warning announcement that the balance or credit is about to run out, or to load some additional balance or to accomplish some other proceedings in accordance with the used payment service.

When the MS roams into an area of another cell at stage 304, the new cell may associate another MSC. If this is the case, the HLR of the MS is informed of the change at stage 310. The previous MSC may transmit a message indicating that the current MSC and thus also the VLR has been changed, and also the balance left in the previous VLR. This information may be sent to the user account of the central node or unit implementing the service (e.g. the HLR or the IN), or then this balance left information may be transmitted directly to the new VLR. After the “balance left” information is successfully transmitted, the temporal local balance in the previous VLR is deleted.

The new MSC is provided with the balance information during the handover procedures. As already explained, this transmission of the subscriber related information including the balance information may be originated from the central user account in the IN or in the HLR, or directly from the previous MSC. After the VLR of the current MSC receives the balance information, it is stored and used in the in current “local” MSC to locally provide the payment services.

The solution can also be implemented such that a roaming call forwarding is also covered, i.e. that it is used in occasions where calls are terminated to an inter-network roaming subscriber, e.g. when the subscriber is abroad (in Sweden in FIG. 1). In case an inter-network roaming subscriber originates calls or similar services requiring prepayment functionality, some triggering and verifying proceedings are required so as to be able to define that the visited foreign MSC supports also prepaid service subscribers. This may need some amendments to the current signalling, e.g. with regards to MAP (Mobile Application Part) signalling, so as to enable the balance information transmittal between various operators and various countries (Sweden and Finland in the example of FIG. 1). To provide this, it is possible to use e.g. the following already existing services.

According to one scenario an Advice of Charge (AoC) supplementary service can be utilized when implementing the prepayment service for the inter-network roaming subscribers. The AoC service is well defined by ETSI (European Telecommunications Standards Institute), e.g. in specification GSM 02.86 (ETS 300ÿ519: European digital telecommunications system (Phase 2); Advise of Charge (AoC) supplementary services Stage 1), December 1995, which discloses main principles and features of the Advice of Charge (AoC) service and thus it is incorporated herein by this reference.

The AoC service is initially created to provide the subscriber with an information indicating an estimated cost of a call or a service used, i.e. a cost for every applicable usage of telecommunications services. The AoC service is subscribed from a service provider, such as from the home network operator, who activates said AoC service e.g. by means of HLR or IN. In the AoC the costs can be expressed in home units, the value of which is defined and published by the HPLMN (Home Public Land Mobile Network) regardless of the LPLMN (Local Public Land Mobile Network) in which the costs were incurred or regardless of the call direction or regardless of the type of call including supplementary service and data cells. Therefore the information used in the AoC can, according to one embodiment, be applied directly to the prepayment operations, as the balance information can be in the home units (currency) as well. It is also possible to include the balance information messages in the AoC signalling.

Referring again to FIG. 2, the intelligent peripheral 176 may be used e.g. to provide different voice synthesis announcements to the subscribers and receive/decode digits from dual tone multi-frequency (DTMF) telephones. In addition, the intelligent peripheral 176 may also receive voice inputs (rather than only DTMF tones) and employ suitable voice recognition software to decode subscriber responses. While the intelligent peripheral 176 may be included within the SSP 160, it may also be provided as a separate node accessible by the service switching point SSP 160 through the switching function 174 thereof.

As explained, the central node comprises the databases for various accounts for the users (i.e. the user accounts). In the IN these can be implemented within the SCP. The SCP can be defined as an electronic control unit which controls the SSP by means of the INAP protocols (for details, see the recommendation CS-1). The SCP monitors the calls and accomplishes the charging operations from the user related debit accounts. As can be seen from FIG. 1 the SSP and the SCP may be connected to one of the exchanges of the PSTN, or they can also be implemented within or connected directly to the MSC of a mobile network.

It is preferred that the user accounts (both the central account in the central node and the local account in the visited local MSC) are implemented such that they are utilizing similar units as is used in conventional PLMN systems for normal call charging occurring e.g. once a month (they can be loaded e.g. by time based units).

According to one alternative, the accounts are so called pulse accounts. These are known e.g. from the prepaid card arrangements already referred to, and are thus not explained further than by mentioning that the electronic pulses in the account equal to a certain amount of money in a certain currency, e.g. such that 1 pulse=10 pennies.

The service provider acts like a ‘bank’ for the subscribers. The service provider may e.g. sell units to be loaded into the central user account by vouchers, call cards or similar means. The central user account can also be loaded by the operator, e.g. such that the subscriber agrees to pay once a month a lump sum in advance, which is then loaded to the account for enabling the use of the prepayment service. The units are then transferred on request from the central account into the local user accounts in the visited MSCs, as explained above.

FIG. 4 discloses an example of the actual payment operation, and more precisely, a payment procedure for prepaid calls. At step 400 the subscriber initiates the call. In case the subscriber desired to use the prepayment function, the dialling can be started with a specific number string, or then there may be a delay after which the prepayment service can be bypassed, i.e. the dialling for calls charged by the prepayment service has to be performed immediately. When the call initiation enters the MSC, the user can be informed about the remaining balance (step 402). In case the local account has balance, a dialling tone is given (step 408). As the subscriber hears the dialling tone he/she selects the desired number (step 410). In case there is no balance or credit left, the call is disconnected. The user may be given some further instructions, such as an advice to load more balance in the central account (step 406).

The PLMN system receives the numbers, verifies the correctness thereof and then accomplishes the required routing operations in the network system, connects the speech path and deliverers the required signalling. In case the receiving end is able to receive the call (i.e. is not busy, and responds at step 412), the call becomes established and call monitoring operations start (step 416). For instance, it is possible to control the price of the call in real time such that the charging units generated during the call are transmitted to the MSC. A payment functionality in the MSC calculates the charges for the call in real time on the basis of the charging information (provided e.g. by means of the AoC) and the balance in the local account is reduced accordingly as the call progresses. In case the balance runs out, the MSC may immediately disconnect the call (for instance, by using the Call Teardown functionality at step 420).

The MSC may have fetched some additional the subscriber data from the database of the subscriber record in the central node. The data may include information about the charges of the call, e.g. the maximum charges allowed for the call. In this case the call will be disconnected accordingly, or another controlled procedure will follow. This other procedure is also indicated in the data. The data may give instructions to provide the subscriber with a voice message indicating that the call will be disconnected in a moment or that the upper limit set for the charges has been reached or the like.

When ending the call, the call is released in accordance with the normal signalling protocols of the telephone network. When the balance of the account runs out, the subscriber is notified about this and the call may be released after a predefined delay, or the call continues and a notification of the amount of money left in the account is given. When the balance runs out, a further notification is given and the call is switched off. In case no balance (or money) is left in the account, the subscriber may, however, use the basic network as before and pay from the used time and calls according to the regular fees of the operator. In this context it is noted that the subscriber is not necessarily forced to use the prepayment function for all calls, but that he/she may be provided with a possibility to use the prepayment service in parallel with a conventional charging functionality.

Thus, the invention provides a solution by which a significant improvement can be achieved in the area of payment services implemented through a telecommunications system. The arrangement according to the present invention is easy and economical to realize by per se known components in the already existing telecommunications systems. It should be noted, however, that the foregoing examples of the embodiments of the invention are not intended to restrict the scope of the invention to the specific forms presented above but the present invention is meant rather to cover all modifications, similarities and alternatives which are included in the spirit and scope of the present invention, as defined by the appended claims.

1. A method of paying services through a cellular telecommunications system, said cellular telecommunications system comprising a user account providing a balance to a user and accessible through the telecommunications system, wherein the balance on the user account is deductible on request, and a switching centre through which the user is currently communicating by means of a mobile station, wherein the switching centre includes a database for storing information relating to the user,
the method comprising a step of transmitting a balance information from the user account to the switching centre the user is currently communicating with.

2. A method according to claim 1, wherein the user account for prepayment services is implemented by means of a central node, such as a Home Location Register (HLR) implemented in a home switching centre of the user or an Intelligent Network (IN) service operationally connected to the cellular system.

3. A method according to claim 1, wherein the balance information is transmitted from the user account to a Visitor Location Register (VLR) implementing said database of the current switching centre, and upon payment a corresponding amount of balance is deducted from a balance indicated by the received balance information in the register of the switching centre.

4. A method according to claim 1, wherein the balance information is transmitted to the current switching centre as a response to a message indicating that the mobile station has roamed from a first switching centre to another switching centre or as a response to a message indicating that a the mobile station has been switched to the current switching centre.

5. A method according to claim 4, wherein the message includes a remaining balance information concerning the balance left in the first switching centre before the roaming occurs.

6. A method according to claim 5, wherein the remaining balance information is transmitted to the user account or directly to said another switching centre, and thereafter the remaining balance in the database of the first switching centre is deleted.

7. A method according to claim 1, wherein the Advise of Charge (AoC) service is used for communicating the information required for a payment.

8. An arrangement for providing a prepayment service for a user communicating by means of a mobile station in a cellular telecommunications system, comprising
a user account accessible through the telecommunications system, wherein the user account is arranged to enable the user to pay for the services in beforehand by having balance on said user account deductible upon a request,
a switching centre through which the user is enabled to communicate towards the telecommunications system by means of the mobile station, the switching centre including a database for storing user related information,
wherein the arrangement is such that the switching centre the user is currently switched to is arranged to receive and locally control and process a balance information transmitted from the user account to the switching centre.

9. An arrangement according to claim 8, wherein the user account for prepayment services is implemented by means of a central node, such as a Home Location Register (HLR) implemented in a home switching centre of the user or an Intelligent Network (IN) operationally connected to the cellular system.

10. An arrangement according to claim 8, wherein the balance information is transmitted from the user account to a Visitor Location Register (VLR) of the current switching centre, and an amount corresponding the payment is deducted from a balance indicated by means of the received balance information in the Visitor Location Register of the current switching centre.

11. A switching centre for a cellular telecommunications system, comprising:
a local database for receiving and storing user related information,
a local user account implemented by means of said database,
means for controlling and processing balance information received from a central user account and stored in said local user account as a local balance.

12. A switching centre according to claim 11, wherein the means for controlling and processing the balance information are arranged to transmit a remaining balance information from the switching centre when a the mobile station of the holder of the central user account is disconnected from the switching centre and thereafter to empty the local user account.
